(19) United States
(12) Patent Application Publication
(10) Pub. No.: US 2007/0135978 A1
(43) Pub. Date: Jun. 14, 2007

(54) Vehicle status monitoring apparatus and method

(76) Inventors: Jae Myoung Kim, Daejeon-city (KR); Dong Sun Lim, Daejeon-city (KR); Heung Nam Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/635,202

(22) Filed: Dec. 7, 2006

(30) Foreign Application Priority Data
Dec. 8, 2005 (KR) 10-2005-0119298
Sep. 29, 2006 (KR) 10-2006-0096637

(51) Int. Cl. G06F 19/00

(52) U.S. Cl. 701/29; 340/438

(57) ABSTRACT

There is provided a vehicle status monitoring apparatus and method including a vehicle status sensing unit sensing an external or internal status of a vehicle by using a sensor or an RFID (radio frequency identification) device and determining whether or not the sensed status of the vehicle deviates from a predetermined critical value range; an information collector periodically receiving position information and image information of the vehicle from a GPS (global positioning system) and an image capturing apparatus mounted inside the vehicle, respectively, when the status is determined to deviate from the critical value range; and a transmitter periodically transmitting the received position information and the image information. Accordingly, the abnormal status is sensed, and the mobile phone, which is secured through the authentication between the telematics terminal and the service center, is immediately informed about the abnormal status so that the user can periodically manage the position information and the image information until the end of the abnormal situation. Therefore, when the vehicle is stolen or the abnormal status of the vehicle occurs, the user can immediately and continuously track the vehicle and manage the abnormal status.

### CROSS-REFERENCE TO RELATED PATENT APPLICATION

This application claims the benefit of Korean Patent Application No. 10-2005-0119298, filed on Dec. 8, 2005 and Korean Patent Application No. 10-2006-0096637, filed on Sep. 29, 2006, in the Korean Intellectual Property Office, the disclosures of which are incorporated herein in their entirety by reference.

### BACKGROUND OF THE INVENTION

1. Field of the Invention

The present invention relates to a vehicle status monitoring apparatus and method. Particularly, the present invention provides a vehicle status monitoring apparatus and method capable of continuously checking a vehicle in order for remote user to monitor the status of a vehicle.

2. Description of the Related Art

Conventionally, when a vehicle is stolen, information on simply captured images and position information from a global positioning system (GPS) informing about an abnormal status of the object sensed by an impact sensor or a door open sensor is transmitted as a short sentence message through a wireless communication network, or the simply captured images are transmitted, so that the status of the vehicle cannot be accurately perceived, and it is difficult to continuously track the vehicle when in the abnormal status.

In order to solve the aforementioned problem, the present invention provides a vehicle status monitoring apparatus and method capable of continuously checking a status of a vehicle by a user by tracking and storing a monitoring result of the vehicle, so that the user can check and manage the status until it ends, even though the user is far from the stolen vehicle.

### SUMMARY OF THE INVENTION

The present invention provides an apparatus for detecting an abnormal status of a vehicle. For example, there is provided a system constructed so as to have a telematics terminal including a ubiquitous sensor, an image recognition camera, a global positioning system (GPS) receiver, and a wireless communication interface, a service center for managing the terminal and information received from the terminal, and a mobile phone of a user. Accordingly, the user can activate a service by means of a user and terminal authentication process between the telematics terminal and the service center, and a change in the status of the vehicle is determined and thereby the user is informed about the change in status. In addition, information obtained by the image recognition camera and the GPS receiver is periodically transmitted in order to be managed by the service center. Therefore, the user can monitor the change in status by means of the service center, and can track and manage the status until it ends.

According to an aspect of the present invention, there is provided a vehicle status monitoring apparatus including; a vehicle status sensing unit sensing an external or internal status of a vehicle by using a sensor or a radio frequency identification (RFID) device and determining whether or not the sensed status of the vehicle deviates from a predetermined critical value range; an information collector periodically receiving position information and image information of the vehicle from a global positioning system (GPS) and an image capturing apparatus mounted inside the vehicle, respectively, when the status is determined to deviate from the critical value range; and a transmitter periodically transmitting the received position information and the image information.

The position information and the image information transmitted from the transmitter may be sequentially stored in a telematics server.

The telematics server may transmit abnormal status alarming information informing a vehicle owner that the vehicle status deviates from the critical value range when the telematics server receives the position information and the image information.

According to another aspect of the present invention, there is provided a vehicle status monitoring system including: a telematics vehicle terminal sensing an external or internal status of a vehicle by using a sensor or an RFID device, periodically receiving position information and image information from a GPS and an image capturing apparatus mounted inside the vehicle, respectively, when the sensed status of the vehicle deviates from a predetermined critical value range, and transmitting the information; a telematics server receiving the position information and the image information from the vehicle terminal and sequentially storing the information; and a terminal receiving from the telematics server abnormal status alarm information informing that the vehicle status deviates from the critical value range and connecting with the telematics server to check the sequentially stored position information and the image information of the vehicle.

According to another aspect of the present invention, there is provided a vehicle status monitoring method including: sensing an external or internal status of a vehicle by using a sensor or an RFID device; periodically receiving position information and image information of the vehicle through a GPS and an image capturing apparatus mounted inside the vehicle, respectively, when the sensed status of the vehicle deviates from a predetermined critical value range; and periodically transmitting the received position information and the image information.

### BRIEF DESCRIPTION OF THE DRAWINGS

The above and other features and advantages of the present invention will become more apparent by describing in detail exemplary embodiments thereof with reference to the attached drawings in which:

FIG. 1 is an internal block diagram showing a vehicle status monitoring apparatus;

FIG. 2 is a view showing positions where a vehicle status monitoring apparatus and an image capturing apparatus are mounted according to an embodiment of the present invention;

FIG. 3 is a block diagram showing a vehicle status monitoring system according to an embodiment of the present invention; FIG. 4 is a flowchart showing a terminal authentication process between a telematics terminal and a telematics server according to an embodiment of the present invention; and

FIG. 5 is a flowchart showing a method of monitoring a vehicle status according to an embodiment of the present invention.

### DETAILED DESCRIPTION OF THE INVENTION

Hereinafter, exemplary embodiments according to the present invention will be described in detail with reference to the accompanying drawings. Like reference numerals in the drawings denote like elements. In the description of the present invention, when a detailed description of known functions or structures is determined to be unnecessary and not to clarify the subject matter of the present invention, the detailed description will be omitted.

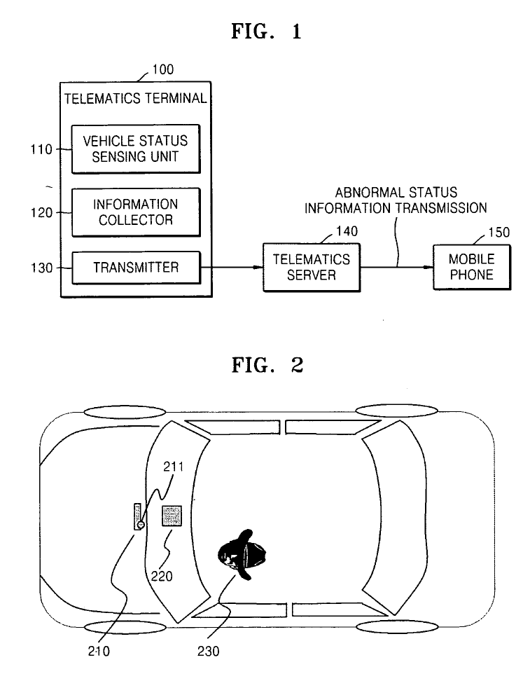

FIG. 1 is an internal block diagram showing a vehicle status monitoring apparatus.

According to an embodiment of the present invention, the vehicle status monitoring apparatus 100 includes a vehicle status sensing unit 110, an information collector 120, and a transmitter 130.

The vehicle status sensing unit 110 senses an external or internal status of a vehicle by means of a sensor or a radio frequency identification (RFID) and determines whether or not the sensed status of the vehicle deviates from a predetermined critical value range. More specifically, the vehicle status sensing unit 110 receives sensor information input by using a vehicle interface including ubiquitous sensors such as an impact sensor, a door open sensor, and the RFID device in order to transmit the sensor information to the vehicle status monitoring apparatus 100. The vehicle status monitoring apparatus 100, which is implemented as a telematics terminal, receives the sensor information and detects a change in the status of the vehicle. For example, an abnormal status such as the generation of an impact in excess of a reference value, a door being opened without using a key or a remote control, and a case where an ID of the RFID is not matched is detected.

When the status of the vehicle (for example, information sensed by the door open sensor or the impact sensor) sensed by the vehicle status sensing unit 110 is in excess of the predetermined critical value, the information collector 120 periodically receives position information obtained by a global positioning system (GPS) receiver and image information obtained by an image capturing apparatus mounted inside the vehicle. In this case, the image capturing apparatus such as a camera and a camcorder is disposed in the left lower portion of a rear-view mirror so as to capture images of passengers in the vehicle. Since the rear-view mirror is always normally disposed at a fixed position in the vehicle, the apparatus for monitoring intruders may not be detected.

The transmitter 130 transmits the position information and the image information periodically received from the information collector 120, that is, information on a position that can be detected from the interface and a capturing speed depending on the performance of the camera, to the telematics server 140. For example, the information is transmitted at a slower speed between the capturing speed of “one frame per second” and a transmitting speed.

The telematics server 140 sequentially stores and manages the position information and the image information that are periodically received from the vehicle status monitoring device 100. In addition, when the telematics server 140 receives the position information and the image information, the telematics server 140 transmits abnormal status alarm information which informs a vehicle owner by means of a mobile phone 150 that the status deviates from the critical value. When a user receives the alarm information, the user connects with the telematics server 140 in order to monitor the abnormal status of the vehicle and checks the monitoring image information stored in the server 140.

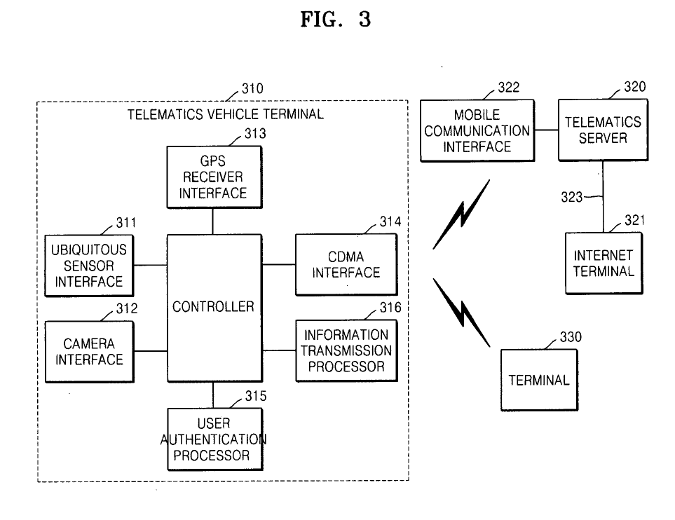

FIG. 2 is a view showing positions where the vehicle status monitoring apparatus and the image capturing apparatus are mounted according to an embodiment of the present invention.

The vehicle status monitoring apparatus according to an embodiment of the present invention can be implemented as a telematics terminal, but is not limited thereto.

The vehicle status monitoring apparatus 220 is mounted inside the vehicle so that a driver 230 cannot see the mounted interface. More specifically, interface wires of the image capturing apparatus inside the rear-view mirror are installed in a vehicle frame, or the image capturing apparatus 211 wirelessly interfaces with the terminal device. The image capturing apparatus 211 such as a camera or a camcorder is disposed in the vehicle so as to capture images of passengers. For example, as shown in FIG. 2, the image capturing apparatus 211 can be disposed in the left lower portion of the rear-view mirror 210.

When the image capturing apparatus 211 is disposed in the left portion of the rear-view mirror 210 and is attached to the rear of a glass of the rear-view mirror 210, the driver 230 cannot see the image capturing apparatus 211. However, the image capturing apparatus 211 always faces the face of the driver 230, so that there is an advantage in that a status of the driver can be easily detected. The position where the image capturing apparatus is disposed is not limited thereto, any may be modified so as to be positioned in various manners.

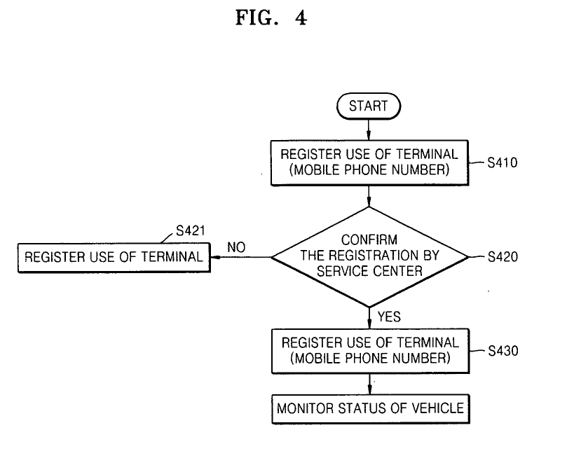

FIG. 3 is a block diagram showing a vehicle status monitoring system according to an embodiment of the present invention.

The vehicle status monitoring system includes a telematics vehicle terminal 310, a telematics server 320, and a terminal 330.

The telematics vehicle terminal 310 senses an external or internal status of the vehicle by means of a sensor or an RFID device. When it is determined that the status of the vehicle included in information obtained by the sensor or the RFID device deviates from a predetermined critical value range, the telematics vehicle terminal 310 periodically obtains position information by using the GPS and obtains image information by using the image capturing apparatus mounted inside the vehicle, and transmits the information to the telematics server 320.

Main interfaces implemented in the telematics vehicle terminal 310 according to the current embodiment include a ubiquitous sensor interface 311, a camera interface 312 to which an image recognition camera is connected, a GPS receiver interface 313, and a code division multiple access (CDMA) interface 314. In addition, the telematics vehicle terminal 310 includes a user authentication processor 315 for performing a user authentication process from the telematics service center 320 and an information transmission processor 316 for transmitting the image information and the GPS information to the telematics service center 320.

The telematics server 320 sequentially stores the position information and the image information received from the telematics vehicle terminal 310. In addition, when it is determined that the status of the vehicle included in the information obtained by the sensor or the RFID device deviates from the predetermined critical value range, the telematics server 320 transmits a message informing the user, by means of the terminal 330, about the abnormal status.

The terminal 330 is a device for receiving emergency information from the telematics vehicle terminal 310 or the telematics server 320. The information stored in the telematics server 320 can be read by using an internet terminal 321 or a mobile phone. In addition, the related information stored in the telematics server 320 can be controlled. In this case, as a communication method, a wireless communication method 323 such as CDMA or wireless broadband (WiBro) is used. The internet terminal 321 can access the telematics server 320 by a wired method or the wireless communication method 323. The vehicle owner or a vehicle status monitoring service subscriber who receives a message by means of the terminal can have access to the telematics server 320 and monitor the position information and the image information on the vehicle sequentially stored in the telematics server 320, so that it is possible to manage the status.

FIG. 4 is a flowchart showing a terminal authentication process between the telematics terminal and the telematics server according to an embodiment of the present invention. The authentication process may be modified in various manners.

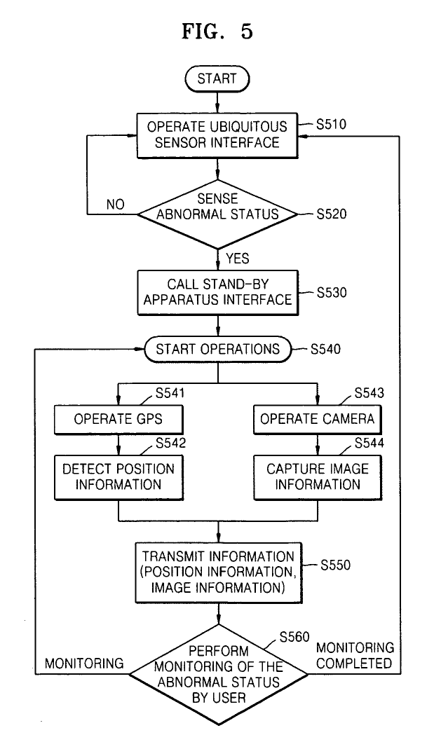

A user registers a mobile phone number used in a service by means of a screen of the telematics terminal in a wireless communication method (operation S410). The service center retrieves an ID of the telematics terminal and confirms the service registration (operation S420). When the mobile phone number is not registered, the user registers the mobile phone number on the service by using the internet terminal (operation S421). When the service registration is completed, the service center stores the terminal ID, user mobile phone information, and user information (operation S430). Thereafter, monitoring of the vehicle status shown in FIG. 5 is performed (operation S440). FIG. 5 is a flowchart showing a method of monitoring a vehicle status.

The telematics terminal mounted inside the vehicle senses an external or internal status of the vehicle by means of the ubiquitous sensor or the RFID device (operation S510). When the sensed vehicle status deviates from the predetermined critical value range (operation S520), the position information and the image information are periodically received from the GPS and the image capturing apparatus mounted inside the vehicle, respectively (operations S530, S540, S541 to S544). The received position information and the image information are then periodically transmitted (operation S550). Thereafter, the user monitors the position information and the image information stored and managed by the telematics server and can manage the status when an abnormal status occurs (operation S560).

Accordingly, the abnormal status is sensed, and the mobile phone, which is secured through the authentication between the telematics terminal and the service center, is immediately informed about the abnormal status, so that the user can periodically manage the position information and the image information until the end of the abnormal status. Therefore, when the vehicle is stolen or the abnormal status of the vehicle occurs, the user can immediately and continuously track the vehicle and manage the abnormal status.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A vehicle status monitoring apparatus comprising;
a vehicle status sensing unit sensing an external or internal status of a vehicle by using a sensor or an RFID (radio frequency identification) device and determining whether or not the sensed status of the vehicle deviates from a predetermined critical value range;
an information collector periodically receiving position information and image information of the vehicle from a GPS (global positioning system) and an image capturing apparatus mounted inside the vehicle, respectively, when the status is determined to deviate from the critical value range; and a transmitter periodically transmitting the received position information and the image information.

2. The vehicle status monitoring apparatus of claim 1, wherein the position information and the image information transmitted from the transmitter are sequentially stored in a telematics server.

3. The vehicle status monitoring apparatus of claim 2, wherein the telematics server transmits abnormal status alarm information informing a vehicle owner that the vehicle status deviates from the critical value range when the telematics server receives the position information and the image information.

4. The vehicle status monitoring apparatus of claim 3, wherein the vehicle owner connects with the telematics server in order to check the sequentially stored position information and the image information on the vehicle when the abnormal status alarm information is received.

5. The vehicle status monitoring apparatus of claim 1, wherein the image capturing apparatus is disposed in a position so as to capture images of passengers in the vehicle.

6. A vehicle status monitoring system comprising:
a telematics vehicle terminal sensing an external or internal status of a vehicle by using a sensor or an RFID device, periodically receiving position information and image information from a GPS and an image capturing apparatus mounted inside the vehicle, respectively, when the sensed status of the vehicle deviates from a predetermined critical value range, and transmitting the information;
a telematics server receiving the position information and the image information from the vehicle terminal and sequentially storing the information; and
a terminal receiving from the telematics server abnormal status alarm information informing that the vehicle status deviates from the critical value range and connecting with the telematics server to check the sequentially stored position information and the image information of the vehicle.

7. The vehicle status monitoring system of claim 6, wherein the image capturing apparatus is disposed in a position so as to capture images of passengers in the vehicle.

8. A vehicle status monitoring method comprising:
sensing an external or internal status of a vehicle by using a sensor or an RFID device;
periodically receiving position information and image information of the vehicle through a GPS and an image capturing apparatus mounted inside the vehicle, respectively, when the sensed status of the vehicle deviates from a predetermined critical value range; and
periodically transmitting the received position information and the image information.

9. The vehicle status monitoring method of claim 8, further comprising sequentially storing the transmitted position information and the image information in a telematics server.

10. The vehicle status monitoring method of claim 9, wherein the telematics server transmits abnormal status alarm information informing a vehicle owner that the vehicle status deviates from the critical value range when the telematics server receives the position information and the image information.

11. The vehicle status monitoring method of claim 10, wherein the vehicle owner connects with the telematics server when the vehicle owner receives the abnormal status alarm information and checks the sequentially stored position information and the image information of the vehicle.

12. The vehicle status monitoring method of claim 8, wherein the image capturing apparatus is disposed in a position so as to capture images of passengers in the vehicle.
